(19) United States
(12) Patent Application Publication
(10) Pub. No.: US 2025/0198506 A1
(43) Pub. Date: Jun. 19, 2025

(54) CONTROL BOX, DESIGN METHOD THEREOF, AND ENGINEERING MACHINERY

(71) Applicants: JIANGSU XCMG CONSTRUCTION MACHINERY RESEARCH INSTITUTE LTD., XUZHOU, JIANGSU (CN); XUZHOU XCMG PORT MACHINERY CO., LTD., XUZHOU, JIANGSU (CN)

(72) Inventors: He LIU, XUZHOU, JIANGSU (CN); Xuemei ZONG, XUZHOU, JIANGSU (CN); Xing ZHANG, XUZHOU, JIANGSU (CN); Xiaofeng TANG, XUZHOU, JIANGSU (CN)

(73) Assignees: JIANGSU XCMG CONSTRUCTION MACHINERY RESEARCH INSTITUTE LTD., XUZHOU, JIANGSU (CN); XUZHOU XCMG PORT MACHINERY CO., LTD., XUZHOU, JIANGSU (CN)

(21) Appl. No.: 18/845,993

(22) PCT Filed: Mar. 17, 2023
(86) PCT No.: PCT/CN2023/082235

§ 371 Date: Sep. 11, 2024

(30) Foreign Application Priority Data
Feb. 22, 2023 (CN) 202310152668.7

(51) Int. Cl. F16H 59/02; B60K 35/60

(52) U.S. Cl. CPC F16H 59/02; B60K 35/60; B60K 2360/135; F16H 2059/026

(57) ABSTRACT

The present application provides a design method for a control box of an engineering machinery, including: determining the mounting positions of at least two types of handles on a box body of the control box, and designing the control box based on the determined mounting positions of the at least two types of handles on the box body of the control box, so that the control box meets the mounting requirement of the at least two types of handles. On such basis, the universality and later expansibility of the control box is improved, and production costs are reduced.

### CROSS-REFERENCE TO RELATED APPLICATIONS

The present application is based on and claims priority to a Chinese application No. 202310152668.7 filed on Feb. 22, 2023, the entire contents of which are incorporated herein by reference.

### TECHNICAL FIELD

The present application relates to the technical field of engineering machinery, and in particular to a control box, a design method thereof, and an engineering machinery.

### BACKGROUND ART

A control box, as an important assembly of an engineering machinery, has the functions of supporting and accommodating handles and other hydraulic or electrical control terminals of an engineering machinery, and is mainly for installation of the handles, electrical elements, braking elements or the like.

In the related art, the control box is usually designed for matching only a certain type of handle, that is to say, the same control box is only able to be equipped with a handle of a certain specification, but not with handles of other specifications, and replacing with another type of handle often requires a completely new matching design, which leads to poor universality and later expansibility of the control box, and tends to result in unnecessary waste and increased cost.

### CONTENT OF THE INVENTION

A technical problem to be solved by the application is to improve the universality and later expansibility of the control box.

In order to solve the above technical problem, the present application provides a design method for a control box of an engineering machinery, including:
determining mounting positions of at least two types of handles on a box body of a control box; and
designing the control box based on the determined mounting positions of the at least two types of handles on the box body of the control box, so that the control box meets mounting requirements of the at least two types of handles.

In some embodiments,
determining mounting positions of at least two types of handles on a box body of a control box includes: determining the mounting positions of the at least two types of handles on the box body of the control box in a height direction; and
designing the control box based on the determined mounting positions of the at least two types of handles on the box body of the control box, so that the control box meets mounting requirements of the at least two types of handles includes: designing the control box based on the determined mounting positions of the at least two types of handles on the box body of the control box in the height direction, so that the control box meets the mounting requirements of the at least two types of the handles in the height direction.

In some embodiments,
determining the mounting positions of the at least two types of handles on the box body of the control box in a height direction includes: determining actual mounting height surfaces and a universal mounting height surface of the at least two types of handles in the box body of the control box; and
designing the control box based on the determined mounting positions of the at least two types of handles on the box body of the control box in the height direction includes: providing, based on the determined actual mounting height surfaces and universal mounting height surface of the at least two types of handles, a support apparatus with a height adjustable between the universal mounting height surface and the actual mounting height surfaces of the at least two types of handles in the box body of the control box, so that in the case of the at least two types of handles being mounted, the at least two types of handles are supported by the support apparatus.

In some embodiments, determining the actual mounting height surfaces and a universal mounting height surface of the at least two types of handles includes:
determining the actual mounting height surfaces of the at least two types of handles; and
taking the actual mounting height surface of any type of handles among the at least two types of handles as the universal mounting height surface of the at least two types of handles.

In some embodiments, taking the actual mounting height surface of any type of handles of the at least two types of handles as the universal mounting height surface of the at least two types of handles includes:
taking the actual mounting height surface of the handle with the lowest actual mounting height surface in the at least two types of handles as the universal mounting height surface of the at least two types of the handles.

In some embodiments, providing a support apparatus with a height adjustable between the universal mounting height surface and the actual mounting height surfaces of the at least two types of handles in the box body of the control box includes:
providing a first bracket in the box body of the control box, and making a top surface of the first bracket flush with the universal mounting height surface; and
connecting or not connecting a second bracket to the first bracket, or replacing second brackets of different height dimensions on the first bracket, such that the height of the support apparatus including the first bracket and the second bracket is adjustable between the universal mounting height surface and the actual mounting height surfaces of the at least two types of handles.

In some embodiments, providing a support apparatus with a height adjustable between the universal mounting height surface and the actual mounting height surfaces of the at least two types of handles in the box body of the control box includes:
providing a first bracket movable in the box body of the control box, and moving the first bracket relative to the control box, such that the height of the support apparatus including the first bracket is adjustable between the universal mounting height surface and the actual mounting height surfaces of the at least two types of handles.

In some embodiments, providing a support apparatus movable in the box body of the control box includes:
providing a vertically-slidable, an telescopic or a rotatable support apparatus in the box body of the control box.

In some embodiments, designing the control box based on the determined mounting positions of the at least two types of handles on the box body of the control box in the height direction includes:
determining, based on the determined mounting positions of the at least two types of handles on the box body of the control box in the height direction, a universal exterior finish of the at least two types of handles, wherein an exterior finish is a top surface of an exterior trim panel of the control box configured to allow the handles to extend into the box body; and
arranging, based on the determined universal exterior finish of the at least two types of handles, an exterior trim panel on a top cover of the box body of the control box, and making the top surface of the exterior trim panel flush with the universal exterior finish.

In some embodiments, determining a universal exterior finish of the at least two types of handles includes:
determining height ranges of the exterior finishes of the at least two types of handles;
in the case where the height ranges of the exterior finishes of the at least two types of handles overlap, selecting a surface at a height position within the overlapping range as the universal exterior finish of the at least two types of handles.

In some embodiments,
determining the mounting positions of the at least two types of handles on the box body of the control box includes: determining the mounting positions of the at least two types of handles on the box body of the control box in a horizontal direction; and
designing the control box based on the determined mounting positions of the at least two types of handles on the box body of the control box, so that the control box meets mounting requirements of the at least two types of handles includes: designing the control box based on the determined mounting positions of the at least two types of handles on the box body of the control box in the horizontal direction, so that the control box meets the mounting requirements of the at least two types of the handles in the horizontal direction.

In some embodiments, designing the control box based on the determined mounting positions of the at least two types of handles on the box body of the control box in the horizontal direction includes:
determining a universal horizontal mounting position of the at least two types of handles based on the determined mounting positions of the at least two types of handles on the box body of the control box in the horizontal direction; and
arranging a through hole configured to allow the handle to pass through at the universal horizontal mounting position on the exterior trim panel of the control box.

In some embodiments, while arranging the through hole configured to allow the handle to pass through at the universal horizontal mounting position on the exterior trim panel of the control box, configuring the through hole to allow the at least two types of handles to pass through.

In some embodiments, configuring the through hole to allow the at least two types of handles to pass through includes:
determining cross-sectional dimensions of portions of the at least two types of handles passing through the through hole;
configuring a cross-sectional area of the through hole, based on the determined cross-sectional dimensions of the portions of the at least two types of handles passing through the through hole, to be greater than or equal to the maximum of the cross-sectional dimensions of the portions of the at least two types of handles passing through the through hole.

In some embodiments, a hand comfort range of a driver is further determined prior to determining the mounting positions of the at least two types of handles on the box body of the control box, wherein the hand comfort range is a hand movement space range within which the driver is capable of comfortably grasping the at least two types of handles, and while determining the mounting positions of the at least two types of handles on the box body of the control box, configuring hand grasping points corresponding to the at least two types of handles to be within the determined hand comfort range.

In some embodiments, determining a hand comfort range of a driver includes:
determining the hand comfort range of the driver according to a sitting posture of the driver in a driving state and/or operating characteristics of the at least two types of handles, wherein the operating characteristics of the at least two types of handles include control modes and/or hand grasping states of the at least two types of handles.

In some embodiments, determining the hand comfort range of the driver according to a sitting posture of the driver in a driving state and/or operating characteristics of the at least two types of handles includes:
determining a first hand comfort range of the driver according to the sitting posture of the driver in the driving state;
based on the determined first hand comfort range, correcting the first hand comfort range according to the operating characteristics of the at least two types of handles, to obtain a second hand comfort range of the driver, wherein the second hand comfort range is smaller than or equal to the first hand comfort range;
determining the second hand comfort range obtained as the hand comfort range of the driver.

In some embodiments, determining a first hand comfort range of the driver according to the sitting posture of the driver in the driving state includes:
determining the sitting posture of the driver in the driving state;
determining hand palm center point data of a first-percentile human model and a second-percentile human model in the driving state based on the determined sitting posture of the driver in the driving state, wherein the second percentile is greater than the first percentile; and
determining the first hand comfort range of the driver based on an overlapping portion of the hand palm center point data of the first-percentile human model and the second-percentile human model in the driving state.

Further, the present application also provides a control box obtained by a design method in any embodiment of the present application.

Furthermore, the present application also provides an engineering machinery including a control box in any embodiment of the present application.

In the design method provided by the present application, a control box is designed to match with at least two types of handles, so that the same control box can meet the mounting requirements of at least two types of the handles rather than only one type of the handle. In this way, the designed control box is compatible with and meet the mounting requirements of the handles of different specifications, and the universality and expandability are effectively improved, which is in favor of reducing wastes and saving costs.

Other features and advantages of the present application will become clear through the following detailed description of exemplary embodiments of the present application with reference to the attached drawings.

### BRIEF DESCRIPTION OF THE DRAWINGS

In order to explain the technical solution in the embodiments of the present application or that in the prior art more clearly, drawings required for describing the embodiments or the prior art will be briefly introduced below. Obviously, the attached drawings described below are only some examples of the present application. Other drawings can also be obtained by those skilled in the art according to these drawings without paying inventive effort.

FIG. 1 is a flow diagram of a design method in some embodiments of the present application.

FIG. 2 is a flow diagram of the design method in other embodiments of the present application.

FIG. 3 is a schematic view showing the positional relationship between the driving posture and a first hand comfort range of a driver.

FIG. 4 is a schematic view showing the movement relationship between a first handle and a hand.

FIG. 5 is a schematic view showing the movement relationship between a second handle and the hand.

FIG. 6 is a schematic view showing the movement relationship between a third handle and the hand.

FIG. 7 is a schematic view showing the movement relationship between a fourth handle and the hand.

FIG. 8 is a schematic view showing the relationship among the first handle, the second handle, the third handle and the fourth handle in a height direction.

FIG. 9 is a schematic view in which the second handle is mounted in the box body.

FIG. 10 is a schematic view in which the first handle is mounted in the box body.

FIG. 11 is a first perspective view of the control box in the embodiment of the present application.

FIG. 12 is a second perspective view of the control box in the embodiment of the present application.

FIG. 13 is a schematic exploded view of a main box in the embodiment of the present application.

### EMBODIMENTS

The technical solutions in the embodiments of the present application will be clearly and completely described with reference to the drawings in the embodiments of the present application. Obviously, the described embodiments are only part of the embodiments of the present application other than the whole embodiments. The following description for at least one exemplary embodiment is merely illustrative in actual and is in no way intended to limit the present application and its application or uses. All other embodiments that are obtained by those skilled in the art based on the embodiments of the present application without paying inventive effort fall within the protection scope of this application.

Techniques, methods and equipment known to those skilled in the art in the related art may not be discussed in detail, but they should be regarded as part of the description under appropriate circumstances.

In the depiction of the present application, it should be understood that the orientation or positional relationship indicated by words describing orientation such as “front, back, up, down, left, right”, “lateral, vertical, perpendicular, horizontal” and “top, bottom” is usually based on the attached drawings shown, just for the convenience of describing the present application and simplifying the depiction. Unless otherwise stated, these words describing orientation do not indicate or imply that the indicated devices or elements must have a specific orientation, or be constructed and operated in a specific orientation, so they shall not be construed as restricting the scope of protection of the present application. The words “inside, outside” refer to the inside and outside relative to the contour of a component itself.

In the depiction of the present application, it should be understood that the words “first”, “second” and the like are used to define parts only for the convenience of distinguishing the corresponding parts from each other. Unless otherwise stated, the above words have no special meaning, and thus shall not be construed as limiting the scope of protection of the present application.

In addition, the technical features involved in different embodiments of the present application described below can be combined with each other as long as they do not conflict with each other.

Engineering machinery is becoming more and more diversified in configuration, and handles to be equipped in match are more and more diversified as well. The specifications of these handles are not the same, for example, electric control handles, thumb handles and hydraulic control handles have different control modes, sizes and working angles. However, in the related art, the control box is often designed for matching only a certain type of handle, that is to say, the same control box can only be equipped with a handle of a certain specification, but cannot be equipped with handles of other specifications, and replacing with another type of handle often requires a completely new matching design. In this case, the control box has poor universality and later expansibility, which tends to lead to unnecessary waste and increased production costs.

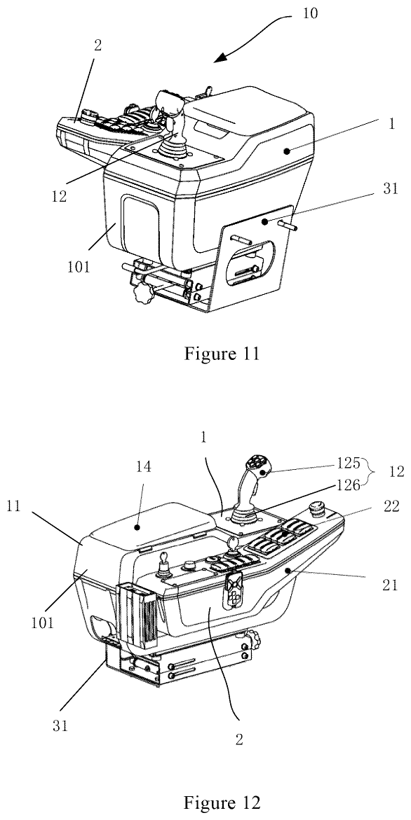

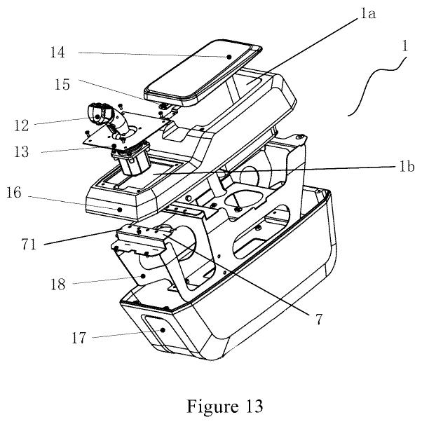

In order to facilitate understanding, the basic structure of the control box is first introduced with reference to FIGS. 11-13.

Referring to FIGS. 11-13, the control box 10 typically includes a box body 101, and control parts such as a handle 12. The handle 12 is disposed on and supported by the box body 101. The box body 101 may be connected to a seat through a connector 31 to move back and forth along with the seat. The box body 101 includes a top cover 16, a housing 17 and a framework 18. The top cover 16 is disposed on the top of the housing 17 and encloses with the housing 17 to form a chamber inside the box body 101. The framework 18 is placed in the chamber enclosed by the top cover 16 and the housing 17. The top cover 16 is provided thereon with an exterior trim panel 13. The exterior trim panel 13 is configured to allow the handle 12 to extend into the box body 101, so that the mounting position of the handle is be shielded by the exterior trim panel 13, so that the handle 12 gives a better looking and is reliable after installation. The exterior trim panel 13 is provided with a through hole 1b, through which the handle 12 passes and extends into the box body 101. A support apparatus 7 for supporting the handle 12 is provided in the interior of the box body 101. The handle 12 extending into the box body 101 through the through hole 1b is supported by the support apparatus 7, so as to realize installation and fixation of the handle 12 on the box body 101. The handle 12 generally includes a handle body 125 and a valve body 126, wherein the handle body 125 is disposed on the valve body 126 to be controlled by a user, and the valve body 126 is arranged under the handle body 125 to support the handle body 125. During installation, the exterior trim panel 13 is substantially mounted within a certain height range at the bottom portion of the valve body 126. A top surface of the exterior trim panel 13 is typically referred to as an exterior finish.

Generally, the control box 10 includes a main box 1 and an auxiliary box 2, and the box body 101 includes a first box body 11 of the main box 1 and a second box body 21 of the auxiliary box 2. The handle 12 is generally arranged on the first box body 11. The second box body 21 is usually provided with electrical elements 22 such as a rocker switch.

In the related art, the box body 101 is only able to meet the mounting requirement of a certain type of handle 12. Specifically, the support apparatus 7 is only able to meet the mounting requirement of a handle 12 of a certain height dimension, and the handles 12 with different height dimensions are only be mounted on different control boxes 10. Moreover, the through hole 1b of the exterior trim panel 13 only allows the handle 12 of a certain cross-sectional size to pass through, and the handles 12 with different cross-sectional sizes need to be equipped with different exterior trim panels 13. In this instance, the control box 10 is difficult to be compatible with the mounting requirements of handles of different specifications, and has poor universality and expandability, which tends to lead to unnecessary waste and increased costs.

In order to solve the problem existing in the related art that the control box is difficult to be compatible with the mounting requirements of handles of different specifications and has poor universality and expandability, the present application provides a control box, a design method thereof, and an engineering machinery.

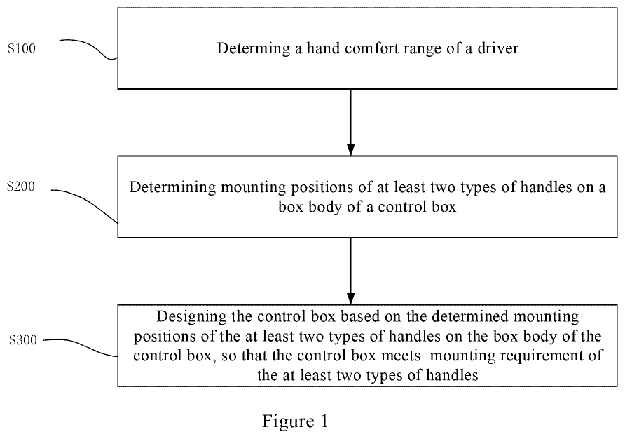

FIGS. 1-13 exemplarily show the control box of the present application and the design method thereof.

Referring to FIG. 1, the design method for the control box provided by the present application includes:
S200, determining mounting positions of at least two types of handles 12 on the box body 101 of the control box 10; and
S300, designing the control box 10 based on the determined mounting positions of the at least two types of handles 12 on the box body 101 of the control box 10, so that the control box 10 meets the mounting requirements of the at least two types of handles 12.

Based on the above steps S200 and S300, the control box 10 is designed to match at least two types of handles 12 in the present application, so that the same control box 10 is able to meet the mounting requirements of at least two types of handles 12 rather than only one type of the handle 12. In such a way, the designed control box 10 is compatible with the mounting requirements of the handles 12 of different specifications, and the universality and expandability are effectively improved, which is in favor of reducing wastes and saving costs.

The mounting positions of the at least two types of handles 12 on the box body 101 of the control box 10 include the mounting positions of the at least two types of handles 12 on the box body 101 of the control box 10 in a height direction, and/or the mounting positions of the at least two types of handles 12 on the box body 101 of the control box 10 in a horizontal direction (for example, in a front-rear direction and/or a left-right direction).

In the case where the mounting positions of the at least two types of handles 12 on the box body 101 include the mounting positions of the at least two types of handles 12 on the box body 101 in the height direction, in some embodiments, the step S200 includes: determining the mounting positions of the at least two types of handles 12 on the box body 101 of the control box 10 in the height direction; and the step S300 includes: designing the control box 10 based on the determined mounting positions of the at least two types of handles 12 on the box body 101 of the control box 10 in the height direction, so that the control box 10 meets the mounting requirements of the at least two types of handles 12 in the height direction.

Based on the above solution, a control box 10 capable of meeting the mounting requirements of different handles 12 in the height direction is designed, so that a single control box 10 is bale to install handles 12 of different height dimensions. In this way, the universality and later expansibility of the control box 10 is effectively improved, repeated design is reduced, and accordingly the design and manufacturing costs are reduced.

In order to meet the mounting requirements of the handles 12 of different height dimensions, the support apparatus 7 of the control box 10 maybe designed. The height of the support apparatus 7 is adjustable between the mounting positions of different handles 12 in the height direction to meet the mounting requirements of the handles 12 with different height dimensions, such that the same control box 10 is able to meet various configuration requirements, thus improved universality and later expandability of the control box 10.

For example, in some embodiments, the aforesaid step “determining the mounting positions of the at least two types of handles 12 on the box body 101 of the control box 10 in the height direction” includes: determining the actual mounting height surfaces and a universal mounting height surface of the at least two types of handles 12 in the box body 101 of the control box 10″; and the aforesaid step “designing the control box 10 based on the determined mounting positions of the at least two types of handles 12 on the box body 101 of the control box 10 in the height direction” includes: providing, based on the determined actual mounting height surfaces and universal mounting height surface of the at least two types of handles 12, a support apparatus 7 with a height adjustable between the universal mounting height surface and the actual mounting height surfaces of the at least two types of handles 12 in the box body 101 of the control box 10, so that in the case of the at least two types of handles 12 being mounted, the at least two types of handles 12 are supported by the support apparatus 7.

In the above solution, the actual mounting height surfaces and a universal mounting height surface of different handles 12 are determined, and the height of the support apparatus 7 is adjustable between the universal mounting height surface and the individual actual mounting height surfaces. In this way, the mounting and fixing demands of the handles 12 with different height dimensions is met by adjusting the support apparatus 7 between the universal mounting height surface and the individual actual mounting height surfaces.

For example, at the initial time, the height of the support apparatus 7 may be flush with the universal mounting height surface, then, when different handles 12 are to be mounted, the height of the support apparatus 7 is adjusted according to a height difference between the actual mounting height surface of each handle 12 and the universal mounting height surface, so that the height of the support apparatus 7 is changed to the actual mounting height surface of the corresponding handle 12, so as to thereby support the corresponding handle 12 and meet the mounting and fixing requirements of the corresponding handle 12. In this case, the universal mounting height surface of the at least two types of handles 12 serves as a basis for the height variation of the support apparatus 7, which is convenient for initial arrangement of the support apparatus 7 and for height adjustment of the support apparatus 7 in the process of replacing the handles 12, so as to efficiently complete the replacement of different handles 12, thereby effectively solving the problem of the difficulty in universal height installation positions of different handles 12.

The universal mounting height surface may be determined in various ways, for example, a surface at any height position in the box body 101 may be served as the corresponding universal mounting height surface, and for another example, the actual mounting height surface of any type of handles 12 of all types of handles 12 to be mounted may also be served as the corresponding universal mounting height surface.

For example, in some embodiments, the aforesaid step “determining the actual mounting height surfaces and universal mounting height surface of the at least two types of handles 12” includes:
determining the actual mounting height surfaces of the at least two types of handles 12; and
taking the actual mounting height surface of any type of handles 12 of the at least two types of handles 12 as the universal mounting height surface of the at least two types of handles 12.

In the above solution, the actual mounting height surfaces of all the handles 12 to be mounted are determined first, and then the actual mounting height surface of any type of handles 12 is taken as the universal mounting height surface of all the handles 12 to be mounted. In this way, the universal mounting height surface is conveniently obtained to serve as a basis for arrangement of the support apparatus 7. In this instance, as the universal mounting height surface is flush with the actual mounting height surface of one of the handles 12 to be mounted, the height of the support apparatus 7 may not be adjusted and may be kept at the universal mounting height surface while mounting of the handle 12 with the corresponding height dimension, and only when the handle 12 with another height dimension is to be replaced, is it necessary to adjust the height of the support apparatus 7, which is beneficial to simplifying the replacement process of the handles and improving the replacement efficiency of the handles.

The actual mounting height surface serving as the universal mounting height surface may either be the lowest actual mounting height surface or the highest actual mounting height surface of all the determined actual mounting height surfaces, or may be any actual mounting height surface between the lowest and highest actual mounting height surfaces of all the determined actual mounting height surfaces.

For example, in some embodiments, the aforesaid step “taking the actual mounting height surface of any handle 12 of the at least two types of handles 12 as the universal mounting height surface of the at least two types of handles 12” includes:
taking the actual mounting height surface of the handle 12 with the lowest actual mounting height surface of the at least two types of handles 12 as the universal mounting height surface of the at least two types of handles 12.

The universal mounting height surface determined by the above means is the lowest actual mounting height surface of all the determined actual mounting height surfaces. In this instance, when the handle 12 with the lowest mounting position in the height direction is to be mounted, it suffices to keep the support apparatus 7 on the universal mounting surface, while when other handles 12 are to be replaced, it is only necessary to adjust the height of the support apparatus 7 support apparatus to a higher position, then the supporting and fixation requirements of the other handles 12 in the height direction are met, which is simple and convenient. The height by which the support apparatus 7 needs to be adjusted is equal to the height difference between the actual mounting height surface of the handle 12 to be replaced and the universal mounting height surface.

Various structural forms may be adopted to make the height of the support apparatus 7 adjustable.

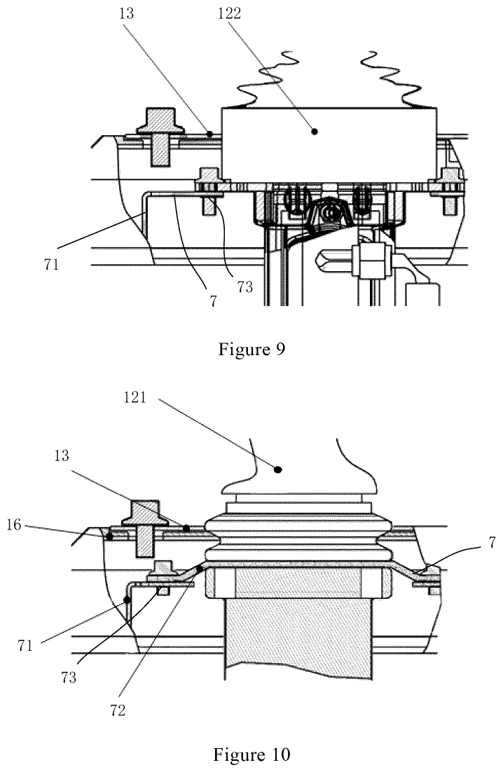

For example, referring to FIGS. 9-10, in some embodiments, the support apparatus 7 includes a first bracket 71, the first bracket 71 is disposed in the first box body 11, and is provided with a connecting part 73 for connection with second brackets 72 of different heights, so as to make the height of the support apparatus 7 adjustable. In this case, the aforesaid step “providing a support apparatus 7 with a height adjustable between the universal mounting height surface and the actual mounting height surfaces of the at least two types of handles 12 in the interior of the box body 101 of the control box 10” may include:
providing a first bracket 71 in the box body 101 of the control box 10, and making a top surface of the first bracket 71 flush with the universal mounting height surface; and
connecting or not connecting a second bracket 72 to the first bracket 71, or replacing the first bracket 71 with a second bracket 72 of different height dimensions, so that the height of the support apparatus 7 including the first bracket 71 and the second bracket 72 varies between the universal mounting height surface and the actual mounting height surfaces of the at least two types of handles 12.

Based on the above solution, the height of the support apparatus 7 is varied by connecting or not connecting a second bracket 72 and by replacing second brackets 72 of different heights, thereby meeting the mounting requirements of the handles 12 with different height dimensions. For example, referring to FIGS. 8-10, in the case where the universal mounting height surface is flush with the actual mounting height surface of one of the handles 12 to be mounted, a first bracket 71 whose top surface is flush with the universal mounting height surface may be arranged in the box body 101, and then second brackets 72 of different height dimensions may be switchably connected to the first bracket 71 (e.g., to an upper side and/or a lower side) to adapt to other handles 12, thereby meeting the mounting requirements of the other handles 12.

For another example, in other embodiments, the support apparatus 7 includes a first bracket 71, which is movably arranged relative to the first box body 11 to make the height of the support apparatus 7 adjustable. In this case, the aforesaid step “providing a support apparatus 7 with a height adjustable between the universal mounting height surface and the actual mounting height surfaces of the at least two types of handles 12 in the interior of the box body 101 of the control box 10” may include:
providing a first bracket 71 movable in the box body 101 of the control box 10, and moving the first bracket 71 relative to the control box 10 to vary the height of the support apparatus 7 between the universal mounting height surface and the actual mounting height surfaces of the at least two types of handles 12.

Based on the above solution, the height of the support apparatus 7 can be adjusted by moving the first bracket 71 relative to the box body 101, so as to meet the mounting requirements of the handles 12 with different height dimensions, thereby improving the universality and later expansibility of the control box 10. The movement of the first bracket 71 may be at least one of the following: vertical sliding, extension and retraction, and rotation. For example, the first bracket 71 may be disposed in the first box body 11 in a vertically-slidable, telescopic or rotatable manner to make the height of the support apparatus 7 adjustable. That is, the aforesaid step “providing a support apparatus 7 movable in the box body 101 of the control box 10” includes: providing a vertically-slidable, telescopic or a rotatable support apparatus 7 in the box body 101 of the control box 10. It should be understanded that, the first bracket 71 sliding vertically means that the first bracket 71 as an entirety slides vertically relative to the first box body 11, and the first bracket 71 being telescopic means that the first bracket 71 includes at least two sections of frame bodies which are configured to slide up and down relatively.

The means of configuring the first bracket 71 to be movable and the means of replacing different second brackets 72 may be used alternatively or together. For example, in the case where the first bracket 71 is provided with the above-mentioned connecting part 73 for connection with second brackets 72 of different heights, the first bracket 71 may be movable or immovable. Under the circumstance of the first bracket 71 being movable, the mounting requirements of the handles 12 of different specifications can be met either by moving the first bracket 71, or by replacing different second brackets 72, thus the means for adapting to handles 12 of different specifications are more flexible, the mounting requirements of the handles 12 within a wider height range are met, which is conducive to further improving the universality and later expandability of the control box 10.

Further, after the mounting position of each handle 12 on the box body 101 in the height direction is determined, not only the support apparatus 7 may be designed as described above, but also the exterior trim panel 13 may be designed.

For example, in some embodiments, the aforesaid step “designing the control box 10 based on the determined mounting positions of the at least two types of handles 12 on the box body 101 of the control box 10 in the height direction” includes:
determining a universal exterior finish of the at least two types of handles 12 based on the determined mounting positions of the at least two types of handles 12 on the box body 101 of the control box 10 in the height direction; and
arranging an exterior trim panel 13 on the top cover 16 of the box body 101 of the control box 10 based on the determined universal exterior finish of the at least two types of handles 12, and making a top surface of the exterior trim panel 13 flush with the universal exterior finish.

In the above solution, the universal exterior finish corresponding to all the handles 12 to be mounted is taken as the top surface of the exterior trim panel 13, such that all the handles 12 to be mounted have a unified exterior finish, which is beneficial to making the form and specifications of the control box 10 unified and improving the universality of the control box 10.

In particular, in some embodiments, the aforesaid step “determining a universal exterior finish of the at least two types of handles 12” includes:
determining heights ranges of the exterior finishes of the at least two types of handles 12; and
in the case where the height ranges of the exterior finishes of the at least two types of handles 12 overlap, selecting a surface at a height position within the overlapping range as the universal exterior finish of the at least two types of handles 12.

As mentioned above, the exterior trim panel 13 is usually mounted within a certain height range at the bottom portion of the valve body 126 of the handle 12, that is, it is allowed to mount the exterior trim panel 13 within the corresponding height range. In this case, the exterior finish corresponding to each handle 12 has a height range, and after the mounting position of each handle 12 in the height direction is determined, the height range of the exterior finish corresponding to each handle 12 can be determined. On such basis, in the design process, the height ranges of the external finishes corresponding to all the handles 12 to be mounted are made to overlap, and accordingly a surface at any height within the overlapping range may be taken as a external finish universal for all the handles 12 to be mounted, that is, may serve as a universal external finish.

It can be seen that, the universal external finish for all the handles 12 to be mounted is determined conveniently based on the above steps, which facilitates to complete the universal design of the control box 10.

As mentioned above, the mounting position of the handle 12 on the box body 101 of the control box 10 may include the mounting position of the handle 12 on the box body 101 of the control box 10 in the horizontal direction. In this instance, the step S200 may include: determining the mounting positions of the at least two types of handles 12 on the box body 101 of the control box 10 in the horizontal direction; and the step S300 correspondingly includes: designing the control box 10 based on the determined mounting positions of the at least two types of handles 12 on the box body 101 of the control box 10 in the horizontal direction, so that the control box 10 meets the mounting requirements of the at least two types of handles 12 in the horizontal direction.

A control box 10 capable of meeting the mounting requirements of different handles 12 in the horizontal direction is obtained by the above solution, so that an installation of handles 12 with different cross-sectional dimensions is achieved by only one single control box 10. In this way, the universality and later expansibility of the control box 10 is effectively improved, repeated design is reduced, and costs are reduced.

In particular, in some embodiments, the aforesaid step “designing the control box 10 based on the determined mounting positions of the at least two types of handles 12 on the box body 101 of the control box 10 in the horizontal direction” includes:
determining a universal horizontal mounting position of the at least two types of handles 12 based on the determined mounting positions of the at least two types of handles 12 on the box body 101 of the control box 10 in the horizontal direction; and
arranging a through hole 1b configured to allow the handle 12 to pass through at the universal horizontal mounting position on the exterior trim panel 13 of the control box 10.

In the above solution, the universal horizontal mounting position refers to a horizontal mounting position universal for all the handles 12, specifically corresponding to the overlapping portion of the actual horizontal mounting positions of all the handles 12. With the determination of a universal horizontal mounting position, all the handles 12 to be mounted can have the same horizontal mounting position, and in actual installation, all the handles 12 can be mounted at the corresponding universal horizontal mounting position, and in this instance, the positions of the through holes 1b (specifically, the positions of the centers of the through holes 1b) on the exterior trim panels 13 for the handles 12 to pass through are the same. Therefore, in the design process of the control box 10, the through holes 1b may be provided at the universal horizontal mounting position on the exterior trim panel 13 for the handles 12 to pass through. As the through holes 1b corresponding to different handles 12 are located at the same position, the universality of the control box 10 is improved and costs are reduced.

Further, in some embodiments, when the through hole 1b at the universal horizontal mounting position for the handle 12 to pass through is provided on the exterior trim panel 13 of the control box 10, configuring the through hole 1b to allow at least two types of handles 12 to pass through. In this way, not only the positions of the through holes 1b corresponding to different handles 12 are the same, but also different handles 12 can pass through the same through hole 1b. On such basis, the through hole 1b is configured to allow different handles 12 to pass through, so that all the handles 12 to be mounted can share the same exterior trim panel 13, and it is unnecessary to replace the exterior trim panel 13 upon mounting of different handles 12. Therefore, it is beneficial to improve the universality of the control box 10, save costs and improve the replacement efficiency of the handles.

In particular, in some embodiments, the aforesaid step “configuring the through hole 1b to allow at least two types of handles 12 to pass through” includes:
determining cross-sectional dimensions of portions of the at least two types of handles 12 passing through the through hole 1b;
configuring a cross-sectional area of the through hole 1b, based on the determined cross-sectional dimensions of the portions of the at least two types of handles 12 passing through the through hole 1b, to be greater than or equal to the maximum of the cross-sectional dimensions of the portions of the at least two types of handles 12 passing through the through hole 1b.

In the above solution, the through hole 1b is designed with the maximum of the cross-sectional dimensions of the portions of all the handles 12 to be mounted passing through the through hole 1b as a reference, such that the through hole 1b that allows all the handles 12 to be mounted to pass through is obtained by configuring the cross-sectional area of the through hole 1b to be greater than or equal to the corresponding maximum cross-sectional dimension value,. which is simple and convenient.

Referring to FIG. 1, in the foregoing embodiments, the design method may include not only steps S200 and S300, but also step S100: determining a hand comfort range of a driver, that is, a hand comfort range of a driver may further be determined prior to determining the mounting positions of the at least two types of handles 12 on the box body 101 of the control box 10. In this instance, upon determining the mounting positions of the at least two types of handles 12 on the box body 101 of the control box 10, the hand grasping points corresponding to the at least two types of handles 12 can all be put within the determined hand comfort range. The hand comfort range is a hand movement space range within which the driver can comfortably grasp the at least two types of handles 12.

In the above solution, “the hand grasping points being within the determined hand comfort range” is taken as a constraint condition in determining the mounting position of each handle 12, such that the determined mounting position of each handle 12 meets the requirement of “the hand grasping points being within the determined hand comfort range”, which means that, in the design process of the control box 10, not only the physical mounting position of different handles 12 is taken into account, but also the hand control comfort of different handles 12 is taken into account. In this way, the designed control box 10 not only meets the mounting requirements of different handles 12, but also bring more comfortable hand control experience after installation of different handles 12. Therefore, it is not only conducive to improving the universality and later expansibility of the control box 10, but also conducive to improving the control comfort of the control box 10.

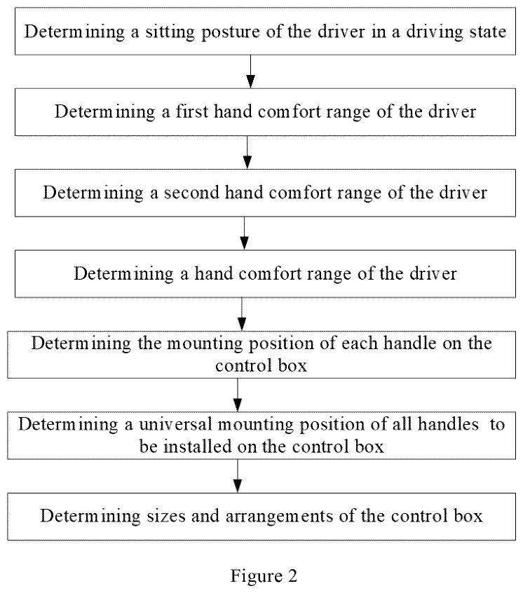

Specifically, referring to FIG. 2, in some embodiments, the aforesaid step “determining a hand comfort range of a driver” includes:
determining the hand comfort range of the driver according to a sitting posture of the driver in a driving state and/or the operating characteristics of the at least two types of handles 12.

In the above solution, the sitting posture of the driver in a driving state refers to the driver's driving sitting posture while. As driver's sitting posture affects the hand movement range of the driver, and further affects the driving comfort of the driver, an appropriate hand comfort range of the driver can be determined according to the sitting posture of the driver in the driving state, effectively solving the problem that control comfort is difficult to be guaranteed after installation of different handles 12 because of the driving sitting posture of the driver being different. The sitting posture of the driver in the driving state may be determined based on the posture of human foot and the travel range of the seat and on the premise that pedaling action can be easily performed with the foot. In addition, when determining the sitting posture of the driver in the driving state, the figures of different groups of people may be taken into consideration, so that the determined hand comfort range meets the comfort requirements of people with different figures. For example, in the determining process, data of human models of three percentiles may be taken to determine the sitting posture of the human models of three percentiles in the driving state respectively, and then a sitting posture that covers the human models of the smallest and the largest percentiles may be taken as the target sitting posture. The three percentiles may be a first percentile, a second percentile and a third percentile respectively. The first percentile is smaller than the second percentile, and the third percentile is greater than the first percentile and smaller than the second percentile. For example, the first percentile is 5th percentile, the second percentile is 95th percentile, and the third percentile is 50th percentile. The population at the 5th percentile is mainly composed of people with smaller body sizes, generally 155 cm high and 52 kg in weight; the 50th percentile population is mainly composed of people with medium body sizes, generally 173 cm high and 75 kg in weight; and the 95th percentile population is mainly composed of people with larger body sizes, generally 190.5 cm high and 114 kg in weight.

In addition, in the above solution, the operating characteristics of the at least two types of handles 12 include the control modes and/or the hand grasping states of the at least two types of handles 12. The control mode of the handle 12 mainly refers to the movement dimension of the handle 12 in the controlled process, that is, the movement dimension of the handle 12 in the front-rear direction, in the left-right direction and in the circumferential direction in the controlled process, including “forward+ backward bidirectional dimensions”, “forward+ backward+ leftward+ rightward four-directional dimensions” and “forward+ backward+ leftward+ rightward+ circumferential five-directional dimension” and so on. The hand grasping state of the handle 12 mainly refers to the number of fingers in contact with the handle during normal control of the handle 12, including single-finger control, three-finger control, full-palm control and the like. Different types of handles 12 usually differ in the control mode and the hand grasping state. Different control modes and hand grasping states affect the hand movement range of the driver while controlling the handle 12, and thereby affect whether the driver controls the handle 12 comfortably. Therefore, an appropriate hand comfort range of the driver can be determined according to the control modes and/or the hand grasping states of the at least two types of handles 12, which effectively solves the problem that control comfort is hard to be guaranteed after installation of different handles 12 on the same control box 10 due to different control characteristics of different handles 12.

It can be seen that in the above solution, when determining the hand comfort range of the driver, an appropriate hand comfort range is obtained by taken into account the sitting posture of the driver in the driving state and/or the operating characteristics of different handles 12, so that a comfortable experience is always brought after installation of different handles 12 on the same control box 10, thereby effectively improving the control comfort of the control box 10.

Specifically, referring to FIG. 2, in some embodiments, the aforesaid step “determining the hand comfort range of the driver according to the sitting posture of the driver in the driving state and/or the operating characteristics of the at least two types of handles 12” includes:
determining a first hand comfort range of the driver according to the sitting posture of the driver in the driving state;
based on the determined first hand comfort range, correcting the first hand comfort range according to the operating characteristics of the at least two types of handles 12, to obtain a second hand comfort range of the driver, which is smaller than or equal to the first hand comfort range;
determining the second hand comfort range acquired as the hand comfort range of the driver.

According to the above solution, in the process of determining the hand comfort range, the driving sitting posture of the driver and the operating characteristics of different handles 12 are both taken into account. Moreover, a larger hand comfort range, namely a first hand comfort range, is determined first based on the driving sitting posture of the driver, then the operating characteristics of different handles 12 are taken into consideration, and the larger first hand comfort range is corrected with a constraint of whether the handles 12 with different operating characteristics can be controlled comfortably, and a second hand comfort range obtained by correction is taken as the final hand comfort range. In this way, the desired hand comfort range is obtained conveniently, and the obtained hand comfort range not only meets the driving comfort of the driver, but also meets the control comfort for different handles 12 by the driver, such that the mounting position of each handle 12 determined based on the corresponding hand comfort range is more in line with the actual comfort requirements, thus beneficial to the design of a control box 10 with better universality and comfort.

In some embodiments, the aforesaid step “determining a first hand comfort range of the driver according to the sitting posture of the driver in the driving state” includes:
determining the sitting posture of the driver in the driving state;
determining hand palm center point data of the first-percentile human model and the second-percentile human model in the driving state based on the determined sitting posture of the driver in the driving state; and
determining a first hand comfort range of the driver based on an overlapping portion of the hand palm center point data of the first-percentile human model and the second percentile human model in the driving state.

According to the above solution, in the process of determining the first hand comfort range based on the driving sitting posture of the driver, the hand comfort ranges of people with different figures are taken into consideration, and a hand comfort range that covers the comfort of people in the range from the first percentile (e.g., 5th percentile) to the second percentile (e.g., 95th percentile) is obtained by determining the first hand comfort range based on the overlapping portion of the hand palm center point data corresponding to human models of two different percentiles (namely, the first percentile and the second percentile) in the driving states. In this way, the determined first hand comfort range meets the comfort requirements of people of most figures, and a control box 10 designed based on the first hand comfort range meets the comfort of people of most figures.

Next, the design method of the present application will be further explained in combination with the embodiments shown in FIGS. 2-10.

As shown in FIGS. 2-10, in the embodiment, the design method includes the following steps:
1) Determining the sitting posture of the driver in the driving state

A driving sitting posture that covers the human models from the first percentile to the second percentile and that allows the driver's legs and feet to be in a comfortable state is determined based on the body height data of people at the first percentile (5th percentile), the second percentile (95th percentile) and the third percentile (50th percentile).

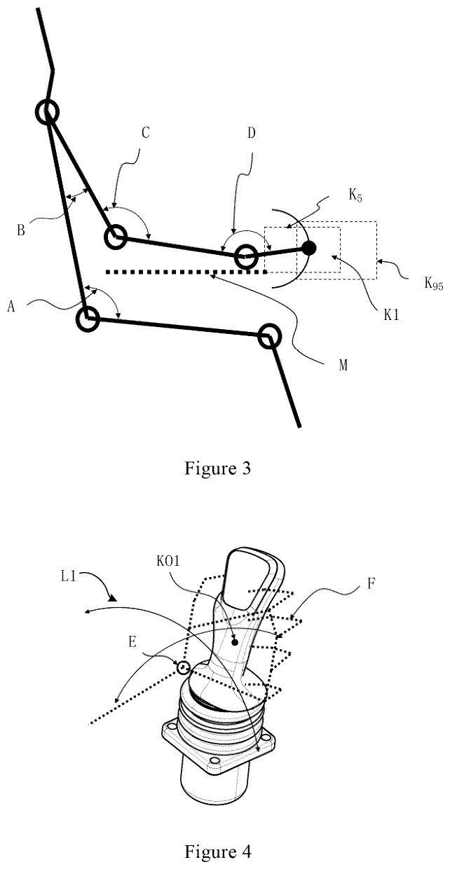

Specifically, in the embodiment, the human model of the 5th percentile is taken as P5=1550 mm, the human model of the 50th percentile is taken as P50=1730 mm, the human model of the 95th percentile is taken as P95=1905 mm, and the sitting posture of the driver in the driving state is obtained (as shown by the solid black line in FIG. 3) based on the posture of human feet and the travel range of the seat on the premise that pedaling action can be easily performed with the feet, with the seat travel covering 5-95 percentile people and the driver's legs and feet being in a comfortable state.
2) Determining the first hand comfort range of the driver

The hand palm center point data of the first-percentile human models and of the second-percentile human models in the determined driving sitting posture of the driver are determined, and then the first hand comfort range of the driver is determined based on the overlapping portion of the hand palm center point data of the first-percentile human models and of the second-percentile human models.

Specifically, as shown in FIG. 3, in the determined sitting posture of the driver in the driving state, the hand palm center point data of P95 human model are recorded as “k95 (L95+ΔX95, W95+ΔY95, H95+ΔZ95), ΔX95∈(0,50), ΔY95∈(0,50),ΔZ95∈(0,50)”, and correspondingly the range of the hand palm center point data is a hand comfort range k95 of the P95 human model in the determined driving sitting posture of the driver. Likewise, the hand palm center point data of P5 human model are recorded as “K5 (L5+ΔX5, W5+ΔY5, H5+ΔZ5), ΔY5∈(0,50), ΔZ5∈(0,50)”, and correspondingly the range of the hand palm center point data is a hand comfort range k5 of the P5 human model in the determined driving sitting posture of the driver. Then, the overlapping portion of the hand palm center point data k95 of the P95 human model and the hand palm center point data k5 of the P5 human model is taken as the first hand range K1.

Thereafter, the first hand comfort range is determined based on the first hand range. Wherein, after the first hand range is determined, the farthest and most critical spatial position of the driver's hand within the corresponding range is obtained. In this instance, the elbow rest height of the control box 10 is determined (as shown by the dotted line M in FIG. 3), and a hip angle A, a shoulder included angle B, an elbow included angle C and a wrist included angle

D of the driver in the driving sitting posture are calculated, so as to verify whether the determined first hand range is appropriate, and if so, the determined first hand range is directly taken as the first hand comfort range. If the hip angle A, the shoulder included angle B, the elbow included angle C and the wrist included angle D are within the ranges of 95°˜120°, 0°˜75°, −15°˜150° and 135°˜180° respectively, the arm and hand of the driver are in the most comfortable state in the corresponding driving posture, which suggests that the determined first hand range is appropriate and the corresponding first hand range can be directly taken as the first hand comfort range. Otherwise, the first hand range is adjusted until the hip angle A, the shoulder included angle B, the elbow included angle C and the wrist included angle D meet the requirements, and then the adjusted first hand range is taken as the first hand comfort range.

The hip angle A refers to the included angle formed between a thigh centerline and a trunk line of the driver in the normal driving or controlling posture. The shoulder included angle B refers to the included angle formed between an upper arm centerline and the trunk line of the driver in the normal driving or controlling posture. The elbow included angle C refers to the included angle formed between the upper arm centerline and a forearm centerline of the driver in the normal driving or controlling posture. The wrist included angle D refers to the included angle formed between the forearm centerline and a hand centerline of the driver in the normal driving or controlling posture.
3) Determining the second hand comfort range of the driver

According to the control modes and the hand grasping states of all the handles 12 to be mounted, the determined first hand comfort range is corrected to obtain a second hand comfort range which is smaller than or equal to the first hand comfort range.

Specifically, the running trajectories of the hand grasping points (KO points) of all the handles 12 to be mounted in different control modes are determined in combination with the hand grasping states and forms based on the principle that the handle can be grasped accurately and tightly, and then three-dimensional models of all the handles 12 to be mounted are placed within the determined first hand comfort range to find out, within the first hand comfort range, a range that covers the running trajectories of the KO points of all the handles 12 to be mounted to serve as the second hand range. Next, whether it meets the surrounding safety clearance requirements is taken as a constraint condition to verify whether the second hand range is appropriate, and if appropriate, the second hand range is taken as the second hand comfort range, or otherwise, the second hand range is adjusted until it meets the safety clearance requirements.

For the sake of safety, each handle 12 has an invisible safety clearance around the KO point, and the corresponding safety clearance enables the handle 12 and the hand to keep a safe distance from the surrounding components without the risk of collision during the control of the handle 12.

More specifically, in this embodiment, there are four types of handles 12 to be mounted, namely, a first handle 121, a second handle 122, a third handle 123 and a fourth handle 124 as shown in FIGS. 4-7. These four types of handles 12 have different cross-sectional dimensions and height dimensions, and their control modes and hand grasping states are also different.

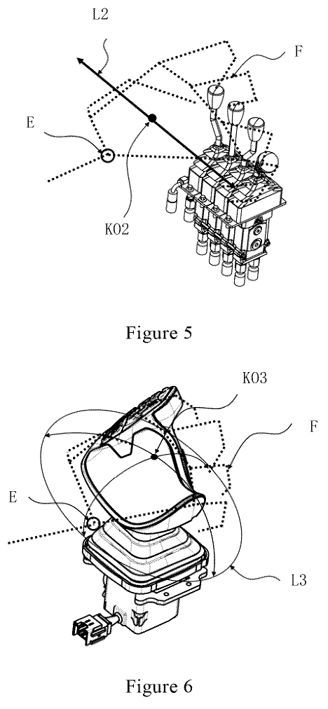

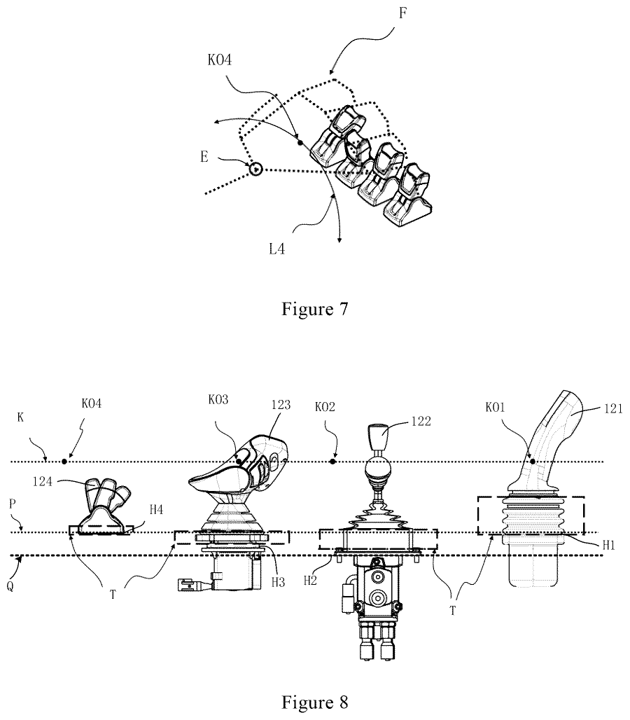

The running trajectories of the KO points of these four types of handles 12 in different control modes are determined in combination with the hand grasping states and forms based on the principle that the handles can be grasped accurately and tightly. FIGS. 4-7 show the running trajectories of the KO points of the first handle 121, the second handle 122, the third handle 123 and the fourth handle 124 respectively. The running trajectory of the KO point of the first handle 121 (denoted as KO1 point in FIG. 4) is “forward+ backward+ leftward+ rightward four-directional dimensions” (as shown by the line L1 in FIG. 4), the running trajectory of the KO point of the second handle 122 (denoted as KO2 point in FIG. 5) is “left-and-right unidirectional dimension” (as shown by the line L2 in FIG. 5), the running trajectory of the KO point of the third handle 123 (denoted as KO3 point in FIG. 6) is “forward+ backward+ leftward +rightward+ circumferential five-directional dimensions” (as shown by the line L3 in FIG. 6), and the running trajectory of the KO point of the fourth handle 124 (denoted as KO4 point in FIG. 7) is “left-right curved dimension” (as shown by the line L4 in FIG. 7). In addition, it should be noted that the dotted line F in FIGS. 4-7 indicates the hand posture, and the point E indicates the wrist moving point.

Afterwards, the running trajectories of the KO points of the four types of handles 12 are matched into the determined first hand comfort range, and, within the first hand comfort range, a range that can cover the running trajectories of the KO points of all the handles 12 to be mounted is find out to serve as the second hand range. Based on the running trajectory of the KO points and the hand size of the 95th percentile people with a length of 207 mm, a width of 96 mm and a thickness of 35 mm, all the KO points in the modes of single-finger control, three-finger control and full-palm control may be determined to be within the first hand comfort range and the movement space range of the hand when controlling the handle in three-dimensional space is determined as the second hand range.

Then, it is verified whether a safety clearance is reserved between the second hand range and the surrounding components. If a mounting clearance has been reserved, the second hand range is determined as the second hand comfort range; or otherwise, the second hand range is adjusted until it meets the safety clearance requirements.
4) Determining the hand comfort range of the driver

The second hand comfort range determined in step 3) is taken as the hand comfort range of the driver.
5) Determining the mounting position of each handle on the control box

The mounting position of each handle 12 on the control box 10 is determined based on the constraint condition that the KO point of each handle 12 can be within the determined hand comfort range, thereby obtaining the mounting position of each handle 12 in the horizontal direction (front-rear direction and left-right direction) and in the height direction.

When determining the mounting position of each handle 12 in the horizontal direction, the maximum physical size of each handle 12 and the spatial size for ensuring effectuation of functions may be taken into account.

When determining the mounting position of each handle 12 in the height direction, it may be taken into account whether the wrist can be in a comfortable state within the hand comfort range during control of each handle 12. Whether the wrist is in a comfortable state may be determined by whether the wrist included angle D is in the range of 0°˜45°. When the wrist included angle D is in the range of 0°˜45°, it is regarded that the wrist is in a comfortable state.
6) Determining the universal mounting position of all the handles to be mounted

The universal horizontal mounting position, the universal mounting height surface and the universal external finish of all the handles 12 to be mounted are determined based on the mounting position of each handle 12 to be mounted on the control box 10, thus acquiring a universal mounting position of all the handles 12 to be mounted, so that the control box 10 is able to well meet the mounting requirements of each handle 12.

The universal mounting position of all the handles 12 to be mounted in the front-rear direction and the left-right direction is obtained, based on the mounting position of each handle 12 in the front-rear direction and the left-right direction, to serve as the universal horizontal mounting position of all the handles 12 to be mounted. Based on the determined universal horizontal mounting position, the position of the through hole 1b on the exterior trim panel 13 in the front-rear direction and the left-right direction is determined.

Further, the height range of the external finish for each handle 12 is counted, and it is judged whether the height ranges of the external finishes for all the handles 12 overlaps. If the height ranges overlap, a horizontal surface corresponding to the most comfortable height within the overlapping range is chosen as the unified exterior finish (i.e. the universal exterior finish) for all the handles 12 to be mounted, to make the external form and specification of the control boxes 10 consistent. The mounting position of the exterior trim panel 13 in the height direction is determined based on the determined universal exterior finish. If the height ranges do not overlap, go back to step 1), and make adjustment until the height ranges overlap.

Furthermore, the mounting position in the height direction of the handle 12 with the lowest mounting position (corresponding to the lowest actual mounting height surface) is chosen, from the mounting positions of all the handles 12 in the height direction (corresponding to the actual mounting height surfaces of all the handles 12), as the universal mounting position of all the handles 12 to be mounted, and the horizontal surface at the corresponding universal mounting position in the height direction is taken as the universal mounting height surface of all the handles 12 to be mounted. The first bracket 71 is arranged based on the determined universal mounting height surface, and the top surface of the first bracket 71 is made to flush with the universal mounting height surface, then the second bracket 72 is arranged according to the height difference between the actual mounting height surfaces of different handles 12 and the universal mounting height surface, to meet the mounting and fixing requirements of different handles 12 in the height direction.

In order to facilitate understanding, the process of determining the above-mentioned universal exterior finish and universal mounting height surface will be further introduced with reference to FIGS. 8-10.

As shown in FIGS. 8-10, the handles 12 of four different specifications are the first handle 121, the second handle 122, the third handle 123 and the fourth handle 124 shown in sequence from right to left in FIG. 8. As shown in FIG. 8, the KO points corresponding to the four handles 12 (that is, the point corresponding to the center of the hand palm when the handle 12 is normally controlled, indicated as KO1, KO2, KO3 and KO4 respectively in FIG. 8) are at the same height position (as shown by the dotted line K in FIG. 8). Moreover, the four handles 12 have a unified exterior finish, that is, the exterior surfaces of the exterior trim panels 13 corresponding to the four handles are at the same height position (indicated by the straight line P in FIG. 8). In FIG. 8, the four dashed rectangular frames T respectively represent the possible height ranges of the exterior finishes corresponding to the four handles 12, and the four dashed rectangular frames overlap each other, which suggests that the four handles 12 are able to be configured to have a unified exterior finish. However, the height positions of the top surfaces of the support apparatuses 7 corresponding to the four handles 12 (that is, the actual mounting height surfaces of the four handles 12) are different. The height positions of the top surfaces of the support apparatuses 7 corresponding to the first handle 121, the second handle 122, the third handle 123 and the fourth handle 124 are shown as H1, H2, H3 and H4 respectively in FIG. 8. By comparison, it can be seen that the top surface of the support apparatus 7 corresponding to the second handle 122 is the lowest, and the top surfaces of the support apparatuses 7 corresponding to the first handle 121, the third handle 123 and the fourth handle 124 are all higher than the top surface of the support apparatus 7 corresponding to the second handle 122. In this instance, the mounting position of the second handle 122 is the lowest, and the height of the top surface of the support apparatus 7 corresponding to the second handle 122 is the lowest. Therefore, in the embodiment, the height position of the top surface of the support apparatus 7 corresponding to the second handle 122 is taken as the height position of the top surface of the first bracket 71 (the corresponding horizontal surface is the universal mounting height surface, which is indicated by the dotted line Q in FIG. 8), and the first bracket 71 is thereby arranged. Thus, when the second handle 122 needs to be mounted, as shown in FIG. 9, the second handle 122 is directly connected to the connecting part 73 without use of the second bracket 72. When the first handle 121 needs to be mounted, as shown in FIG. 10, the second bracket 72, which makes up the height difference between the top surface of the support apparatus 7 corresponding to the first handle 121 and the top surface of the support apparatus 7 corresponding to the second handle 122, is connected to the connecting part 73 and disposed above the first bracket 71, so that the support apparatus 7 meets the mounting requirements of the first handle 121. Similarly, when the third handle 123 or the fourth handle 124 needs to be mounted, a second bracket 72 of a different height dimension is connected to and disposed above the first bracket 71 to match the third handle 123 and the fourth handle 124.
7) Determining the size and layout of the control box

The contour and size of the control box 10 are determined according to different specifications of the handles, and requirements for modular size and number of buttons under different configurations.

The control box is divided into a main operating area and an auxiliary operating area according to use frequency, importance and safety of the control parts.

The main operating area corresponds to the main box 1, with the handle 12 as the main part and the elbow rest 14 as the hand support. The auxiliary operating area corresponds to the auxiliary box 2, which is mainly composed of buttons with different configuration requirements and is distributed in a modular manner. The universal electrical components in different configurations are determined in the auxiliary operating area, and are distributed according to the control mode and human-machine comfort and placed at the same position inside the auxiliary box 2.

The auxiliary operating area determines different control modes and size data between the control parts in different configurations, and the control parts are uniformly placed at the same position inside the auxiliary box 2.

It is verified whether the overall control box 10 has been designed to meet the requirements of size minimization and cost saving on the basis of having the functions effectuated; if not, the overall control box 10 is adjusted.

As can be seen from the foregoing introduction, the design method in the embodiment is based on the comfort of hand control, comprehensively considers the control modes, displacement positions and working angles of different handles 12, and is compatible with the control modes, positions and working angles of multiple types of handles 12 while meeting the size requirements for the multiple types of handles and components, and determines the universal mounting positions of different handles 12 on the control box 10 through good modular design of each component and the universal cooperation with other components, such that the whole control box 10 is universal, which effectively solves the problem of poor hand comfort caused by inconsistent handle control modes and difficulty in sharing the same mounting position by different handles.

The control box 10 obtained by the design method in the embodiment is suitable for various functional configurations, which realizes lightweight design, effectively reduces the mold costs, reduces the manufacturing and assembling difficulty, so that the control box 10 is universal for various products, thereby strongly supporting the lectotype and mating operation of other systems, and greatly reducing the related manufacturing and maintenance costs.

Based on the design methods in the foregoing embodiments, the present application also provides a control box 10, wherein the control box 10 meets the mounting requirements of at least two types of handles 12. Referring to FIGS. 11-13, in some embodiments, a height-adjustable support apparatus 7 is provided in the box body 101 of the control box 10. In some embodiments, the through hole 1b on the exterior trim panel 13 of the control box 10 is configured to allow at least two types of handles 12 to pass through.

In addition, based on the provided control box 10, the present application also provides an engineering machinery. As an example, the engineering machinery is an engineering vehicle such as a loader.

The above is only an exemplary embodiment of this application, and it is not used to limit this application. Any modification, equivalent substitution, modification, etc. made within the spirit and principle of this application should be included in the protection scope of this application.

1. A design method for a control box of an engineering machinery, comprising:
determining mounting positions of at least two types of handles on a box body of a control box; and
designing the control box based on the determined mounting positions of the at least two types of handles on the box body of the control box, so that the control box meets mounting requirements of the at least two types of handles.

2. The design method according to claim 1, wherein:
determining mounting positions of at least two types of handles on a box body of a control box comprises: determining the mounting positions of the at least two types of handles on the box body of the control box in a height direction; and
designing the control box based on the determined mounting positions of the at least two types of handles on the box body of the control box, so that the control box meets mounting requirements of the at least two types of handles comprises: designing the control box based on the determined mounting positions of the at least two types of handles on the box body of the control box in the height direction, so that the control box meets the mounting requirements of the at least two types of the handles in the height direction.

3. The design method according to claim 2, wherein:
determining the mounting positions of the at least two types of handles on the box body of the control box in a height direction comprises: determining actual mounting height surfaces and a universal mounting height surface of the at least two types of handles in the box body of the control box; and
designing the control box based on the determined mounting positions of the at least two types of handles on the box body of the control box in the height direction comprises: providing, based on the determined actual mounting height surfaces and universal mounting height surface of the at least two types of handles, a support apparatus with a height adjustable between the universal mounting height surface and the actual mounting height surfaces of the at least two types of handles in the box body of the control box, so that in the case of the at least two types of handles being mounted, the at least two types of handles are supported by the support apparatus.

4. The design method according to claim 3, wherein determining the actual mounting height surfaces and a universal mounting height surface of the at least two types of handles comprises:
determining the actual mounting height surfaces of the at least two types of handles; and
taking the actual mounting height surface of any type of handles among the at least two types of handles as the universal mounting height surface of the at least two types of handles.

5. The design method according to claim 4, wherein taking the actual mounting height surface of any type of handles of the at least two types of handles as the universal mounting height surface of the at least two types of handles comprises:
taking the actual mounting height surface of the handle with the lowest actual mounting height surface in the at least two types of handles as the universal mounting height surface of the at least two types of the handles.

6. The design method according to claim 3, wherein providing a support apparatus with a height adjustable between the universal mounting height surface and the actual mounting height surfaces of the at least two types of handles in the box body of the control box comprises:
providing a first bracket in the box body of the control box, and making a top surface of the first bracket flush with the universal mounting height surface; and
connecting or not connecting a second bracket to the first bracket, or replacing second brackets of different height dimensions on the first bracket, such that the height of the support apparatus comprising the first bracket and the second bracket is adjustable between the universal mounting height surface and the actual mounting height surfaces of the at least two types of handles.

7. The design method according to claim 3, wherein providing a support apparatus with a height adjustable between the universal mounting height surface and the actual mounting height surfaces of the at least two types of handles in the box body of the control box comprises:
providing a first bracket movable in the box body of the control box, and moving the first bracket relative to the control box, such that the height of the support apparatus including the first bracket is adjustable between the universal mounting height surface and the actual mounting height surfaces of the at least two types of handles.

8. The design method according to claim 7, wherein providing a support apparatus movable in the box body of the control box comprises:
providing a vertically-slidable, an telescopic or a rotatable support apparatus in the box body of the control box.

9. The design method according to claim 2, wherein designing the control box based on the determined mounting positions of the at least two types of handles on the box body of the control box in the height direction comprises:
determining, based on the determined mounting positions of the at least two types of handles on the box body of the control box in the height direction, a universal exterior finish of the at least two types of handles, wherein an exterior finish is a top surface of an exterior trim panel of the control box configured to allow the handles to extend into the box body; and
arranging, based on the determined universal exterior finish of the at least two types of handles, an exterior trim panel on a top cover of the box body of the control box (10), and making the top surface of the exterior trim panel flush with the universal exterior finish.

10. The design method according to claim 9, wherein determining a universal exterior finish of the at least two types of handles comprises:
determining height ranges of the exterior finishes of the at least two types of handles;
in the case where the height ranges of the exterior finishes of the at least two types of handles overlap, selecting a surface at a height position within the overlapping range as the universal exterior finish of the at least two types of handles.

11. The design method according to claim 1, wherein:
determining the mounting positions of the at least two types of handles on the box body of the control box comprises: determining the mounting positions of the at least two types of handles on the box body of the control box in a horizontal direction; and
designing the control box based on the determined mounting positions of the at least two types of handles on the box body of the control box, so that the control box meets mounting requirements of the at least two types of handles comprises: designing the control box based on the determined mounting positions of the at least two types of handles on the box body of the control box in the horizontal direction, so that the control box meets the mounting requirements of the at least two types of the handles in the horizontal direction.

12. The design method according to claim 11, wherein designing the control box based on the determined mounting positions of the at least two types of handles on the box body of the control box in the horizontal direction comprises:
determining a universal horizontal mounting position of the at least two types of handles based on the determined mounting positions of the at least two types of handles on the box body of the control box in the horizontal direction; and
arranging a through hole configured to allow the handle to pass through at the universal horizontal mounting position on the exterior trim panel of the control box.

13. The design method according to claim 12, wherein while arranging the through hole configured to allow the handle to pass through at the universal horizontal mounting position on the exterior trim panel of the control box, configuring the through hole to allow the at least two types of handles to pass through.

14. The design method according to claim 13, wherein configuring the through hole to allow the at least two types of handles to pass through comprises:
determining cross-sectional dimensions of portions of the at least two types of handles passing through the through hole;
configuring a cross-sectional area of the through hole, based on the determined cross-sectional dimensions of the portions of the at least two types of handles passing through the through hole, to be greater than or equal to the maximum of the cross-sectional dimensions of the portions of the at least two types of handles passing through the through hole.

15. The design method according to claim 1, wherein a hand comfort range of a driver is further determined prior to determining the mounting positions of the at least two types of handles on the box body of the control box, wherein the hand comfort range is a hand movement space range within which the driver is capable of comfortably grasping the at least two types of handles, and while determining the mounting positions of the at least two types of handles on the box body of the control box, configuring hand grasping points corresponding to the at least two types of handles to be within the determined hand comfort range.

16. The design method according to claim 15, wherein determining a hand comfort range of a driver comprises:
determining the hand comfort range of the driver according to a sitting posture of the driver in a driving state and/or operating characteristics of the at least two types of handles, wherein the operating characteristics of the at least two types of handles comprise control modes and/or hand grasping states of the at least two types of handles.

17. The design method according to claim 15, wherein determining the hand comfort range of the driver according to a sitting posture of the driver in a driving state and/or operating characteristics of the at least two types of handles comprises:
determining a first hand comfort range of the driver according to the sitting posture of the driver in the driving state;
based on the determined first hand comfort range, correcting the first hand comfort range according to the operating characteristics of the at least two types of handles, to obtain a second hand comfort range of the driver, wherein the second hand comfort range is smaller than or equal to the first hand comfort range;
determining the second hand comfort range obtained as the hand comfort range of the driver.

18. The design method according to claim 17, wherein determining a first hand comfort range of the driver according to the sitting posture of the driver in the driving state comprises:
determining the sitting posture of the driver in the driving state;
determining hand palm center point data of a first-percentile human model and a second-percentile human model in the driving state based on the determined sitting posture of the driver in the driving state, wherein the second percentile is greater than the first percentile; and
determining the first hand comfort range of the driver based on an overlapping portion of the hand palm center point data of the first-percentile human model and the second-percentile human model in the driving state.

19. A control box obtained by the design method as claimed in claim 1.

20. An engineering machinery comprising the control box according to claim 19.
